(19) United States
(12) Patent Application Publication
(10) Pub. No.: US 2011/0113908 A1
(43) Pub. Date: May 19, 2011

(54) RPM MULTIPLIER AND/OR TORQUE INCREASER FOR TURBINES

(76) Inventor: Martin CORRADINI, Mar del Plata - Buenos Aires (AR)

(21) Appl. No.: 12/946,373

(22) Filed: Nov. 15, 2010

(30) Foreign Application Priority Data
Nov. 16, 2009 (UY) 32.248

(51) Int. Cl. F16H 3/087; H02N 11/00

(52) U.S. Cl. 74/325; 74/DIG. 9

(57) ABSTRACT

RPM Multiplier consists of a succession of gears of two different toothed radii each, the smallest ones engage with the biggest and let the successive biggest gears turn in relation to the previous biggest as the smallest. Magnets and electromagnets are placed in the gear teeth and support rails with the purpose of reducing friction. Torque Increaser model B consists of at least a pair of gear rotors, which incorporate electromagnets or magnets; the electromagnetic or magnetic force is used to move the generator together with the main rotor of the turbine.

### RELATED APPLICATIONS

The present application is based on, and claims priority from, Uruguay Application Number 32.248, filed Nov. 16, 2009, the disclosure of which is hereby incorporated by reference herein in its entirety.

### BRIEF DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a diagram of an RPM multiplier according to an embodiment;

FIG. 2 is a diagram of a torque increaser according to an embodiment;

FIG. 3 is a diagram of a conductive washer according to an embodiment;

FIG. 4 is a cross-section diagram of a magnetic support according to an embodiment; and

FIG. 5 is a front view diagram of a torque increaser according to another embodiment.

### DETAILED DESCRIPTION

The RPM Multiplier with Torque Increaser model B for Turbines is especially designed to be applied to the Energy Generation System for Vessels and Submarines through Hydroelectric Turbines and to the Energy Generation System for Automobiles, Motor Vehicles, Auto transports, Machinery and Motorcycles of own invention.

It can be used with any kind of turbine: wind, hydroelectric, etc. It can also be placed between the transmission and the engine in order to increase RPM, torque and power. It can be placed between the transmission and the semi axis for the same purpose. The torque Increaser model B is the cheapest and simplest model of the product range.

The system shows an option to increase RPM, reducing friction, as well as to implement devices (a model is shown in this patent) in order to add a force (electromagnetic, magnetic or combinations, etc) to the force of the main rotor turbine that operates the electrical generator, making it possible to obtain energy with less mechanical work of the main rotor turbine.

Friction gear and the loss of mechanical energy of the Torque Increaser model B are reduced and a force (electromagnetic or magnetic or combinations, etc.) is added to the force (mechanical) of the main rotor turbine that operates the electrical generator, making it possible to obtain electrical energy with less mechanical energy from the main rotor turbine (adding an electromagnetic or magnetic work to the mechanical work of the main rotor turbine).

The set of Multiplier and Torque Increaser model B is placed between the main rotor turbine and the generator. Its purpose is to increase RPM reducing friction to a minimum possible and to add a force (electromagnetic, magnetic or combinations, etc) to a force (mechanical) of the main rotor turbine that operates the electrical generator obtaining electrical energy with less mechanical energy from the main rotor turbine, (adding an electromagnetic or magnetic work to the mechanical work of the main rotor turbine)

The RPM Multiplier with Torque Increaser model B for Turbines consists of a set of gears of different radii placed in order to increase RPM, and gear type rotors used to add a force (electromagnetic, magnetic or combinations, etc.) to the force of the main rotor turbine that operates the electrical generator, making it possible to obtain electrical energy with less mechanical energy from the main rotor turbine (adding an electromagnetic or magnetic work to the mechanical work of the main rotor turbine); and obtaining more electrical energy than the mechanical energy transmitted by the main rotor turbine to the generator through a force (electromagnetic, magnetic or combinations, etc.) placed between them.

The RPM multiplier is composed of gears, each of them of two toothed radii, one bigger than the other. They can have different intermediate radii in order to obtain rigidness. They are engaged as follows: the smallest toothed radius of the second gear will be engaged with the biggest toothed radius of the first gear. Thus, the biggest toothed radius of the second gear will rotate as many times in relation to the biggest toothed radius of the first gear as to the smallest toothed radius of the second.

Magnets, electromagnets or combinations, etc. are placed in the gear teeth in order to reduce friction. As they have the same polarity they will repel each other, reducing friction through that magnetic (or electromagnetic) force.

The Torque Increaser model B (the simplest and cheapest model of the product range) is composed of at least a pair of gear type rotors, whether solid or non-solid, with at least two teeth rows each, working against the rotor generator. The rotor generator, in its outer part, has the same toothed shaped than the pair of gears of the Increaser, but opposite them. The pair of gear type rotors will be engaged with the last gear of the Multiplier and against the rotor Generator which will have in the outer part of its rotor the same amount of teeth rows than the gears of the multiplier. The gear teeth have magnets, electromagnets, combinations, etc in one of their sides, in one direction in the first row and in the opposite direction in the second row, and against them, the ones of the rotor generator. One row works in one direction of rotation, and the other one in the opposite direction.

Electromagnets, magnets or combinations, etc. are repelled adding the electromagnetic (or magnetic) force to the main rotor turbine and operating in combination against the rotor generator. Thus, the rotor generator is operated by the force of the main rotor turbine (mechanical energy) and the electromagnetism or magnetism (electromagnetic or magnetic energy) of the Torque Increaser Model B.

A brief description of the drawing is shown below. It is a perspective and exploded drawing in order to show all its devices. Top: the Multiplier. Middle: the Torque Increaser. Bottom: a sample of electrical conduction washer and a cut of the support rail.

RPM Multiplier, two gears, gear assembly and succession, are shown

Torque Increaser:

G: Gear of the RPM Multiplier

Ra: support rail of the rotor Increaser (rotor device)

In: Increaser in opposite direction of rotation

I: increaser in normal direction of rotation

Gr: rotor generator in the outer part

Fm: magnets or electromagnets fixed to the sarcophagus

The position of the electromagnets or magnets of the Torque Increaser are shaded as an example.

Conductive washer

Shown only as an example, energy transmission is not taken into account in this patent.

M: male

F: female

Support rail: cut of support rail

F: friction area

M: magnets or electromagnets

Support bars are omitted in the drawing since their designs depend on the number and the disposition of the rotors of the Torque Increaser. The dimensions of the drawing does not represent a real scale, they are just shown as a reference.

RPM multiplier with Torque Increaser model B for Turbines.

The multiplier is composed of a succession of gears, each gear of two different toothed radii, one bigger than the other (intermediate radii can be used in order to obtain more rigidness and resistance to torsion and work).

Gears are engaged in such a way that the biggest radius of the first gear engages with the smallest radius of the second, thus, the biggest radius of the second gear rotates as many times in relation to the biggest radius of the first gear as to the smallest radius of the last one, and successively on consecutive gears.

The number of gears and radii will depend on the RPM necessary to make the generator work, based on the number of RPM of the main rotor and taking into account the vessel or vehicle design where it will be applied, as well as the speed, energetic requirements, etc.

The same design can be applied to any type of turbine, i.e., wind turbines, hydroelectric turbines, etc.

The gears are placed in a crank shaft or spiral style, depending on the needs. The crankshaft-like disposition is convenient in case RPM reduction system is needed, which can be connected to the gears of the multiplier in a parallel way. In vessels, machineries and vehicles of limited speed, it is not necessary to reduce RPM, except for special circumstances. In high performance vehicles, it is necessary to reduce RPM as the vehicle increases speed; special reducers will be used for every case in particular. (Reducers designs belong to independent patented inventions).

In order to reduce friction produced by the gears, permanent magnets or electromagnets or combinations, etc. are (optionally) placed in the gear teeth. As they have the same polarity, they repel each other. In order to avoid direct contact with the magnets, same magnets are placed inside a depression in the central area of the gear teeth, the sides of the depression are connected to each preventing magnets from having contact among them and therefore get damaged.

Magnets can be glued, bolted, both, or any other convenient way of fastening, taking into account every case in particular. It is convenient to isolate the contact area between the magnet and the gear (avoiding the gear being magnetized), in relation to the material used for the manufacturing of that particular gear.

Friction is counteracted by the repulsion force of magnets, electromagnets, combinations, etc.

Magnets refrigeration has to be carefully taken into account. They must be continuously and interruptively refrigerated during working. In order to facilitate refrigeration, small magnets or electromagnets separated by grooves will be (optionally) placed. The grooves will be placed successively and between contact areas of the gear.

In case of using electromagnets, electric current will be transmitted through gear grooves which will be isolated, as well as the contact areas between electromagnets and gears. (It represents only one of multiple options).

Every gear is held by beams, bars or rigid panels like bedplates which maintain the gears centered in both sides, by the smallest radius, in a non-toothed section or by a middle one in the case of using them so as to obtain more rigidness.

In order to reduce the friction produced between the gears and the beams, bars or rigid panels like bedplates, permanent magnets or electromagnets or combinations, etc can (optionally) be used as a rail. Magnets are repelled, reducing the friction and maintaining the gears centered inside the beams. This design will be formed of magnets placed opposite the sides and in the centre of the rail, the ones in the center will be repelled, the ones on the sides can be repelled or attracted to each other, the friction area will be only the lateral part of the rail with the magnets and that will make contact with the gear. It is necessary to continuously refrigerate the rail magnets. They will be preferably placed in a succession of small magnets, with space among them, and in that space, grooves in the lateral and central part of the rail will be placed in order to refrigerate them.

Electromagnets can be placed for the same purpose.

Any kind of rail, bearing, etc, can also be used. Magnets are used in order to reduce friction to the minimum possible and to avoid the loss of mechanical energy.

The Torque Increaser model B is preferably placed between the multiplier and the rotor generator. (It can also be put in different places, even before the multiplier). Its purpose is to add a force (electromagnetic or magnetic) to the force of the main rotor turbine that operates de electrical generator, making it possible to obtain more electric energy with less mechanical energy of the main rotor turbine (adding an electromagnetic or magnetic work to the mechanical work of the main rotor turbine), counteracting the energy generator and reducing to the minimum possible the mechanical work of the main rotor turbine that is necessary to operate the generator, obtaining energy giving up less mechanical energy, adding a force (magnetic or electromagnetic or combinations, etc.) between the main rotor turbine (mechanical energy) and the rotor generator.

The Torque Increaser model B is composed of at least a pair of gear type rotors, solid or non-solid, with at least two teeth rows each, placed against the rotor generator. The rotor generator has in its outer part the same design in the opposite direction of the pair of gear type rotors. They are engaged with the last gear of the Multiplier and against the rotor generator. The gear teeth are completely solid in one of their sides and hollow in the other ones. Electromagnets or magnets or combinations, etc, are placed in this hole, the first gear row in one direction and the second row in the opposite direction one row rotates one direction of rotation and the other one in the opposite direction. The amount of gear type rotors placed will depend on the need. Electromagnets are placed in that hole facilitating the supply of electric current.

The rotor generator is embossed on its outer part, but in the opposite direction, and they are engaged with the gears of the Torque Increaser model B.

The gear type rotors of the Torque Increaser are engaged with the gears of the rotor generator. As they have the same polarity they repel each other. Thus, the electromagnetic force, as it adds a force between the main rotor and the generator, works helping the rotor generator rotate, increasing the main rotor torque and reducing the mechanical work necessary to operate the generator.

For example, one of the gear type rotors of the Torque Increaser model B, (the one on the right) will push the rotor generator down, and the opposite gear of the Torque Increaser model B (the one on the left) will push it up (torque principle).

In order to increase the electromagnetic force, fixed electromagnets or magnets can be optionally placed in the skeleton or sarcophagus. Such electromagnets or magnets can be attracted or repelled in the same direction of rotation than the gears of the Torque Increaser model B.

In vessels, the energy necessary for the working of the Torque Increaser model B can be obtained from solar panels, small wind generators (preferably of vertical rotor) or from small hydroelectric turbines without the Torque Increaser. They will keep batteries charged.

In vehicles, the energy can be obtained from solar panels, a small generator without the Torque Increaser, aerodynamic generators or KERS or combinations, which will maintain the batteries charged. (They belong to independent patented inventions).

When a greater force is not necessary, the Torque Increaser model B can be composed of permanent magnets. In such case, the Torque Increaser model B will work in only one direction of rotation.

The Torque Increaser model B is convenient in order to obtain great powers, since it needs energy to work and its purpose has already been explained.

The Torque Increaser model B can be composed of one, two, three or four pairs of gears placed opposite the rotor generator, and their corresponding fixed electromagnets or magnets. Thus, a greater force (electromagnetic or magnetic) is obtained in order to operate the generator.

A double row of gear type rotors against the rotor generator can also be used. The same principle and design are applied, a gear type rotor of the Increaser moves the other gear of the Increaser and they, as a whole, operate the rotor generator. In such case, the intermediate rotors will have electromagnets or magnets on both sides of the teeth.

The rotor generator can be operated by two or more sets of multiplier and increaser, in which case, each increaser will operate one rotor and the rotors will operate the generator.

Electromagnets against electromagnets, electromagnets against magnets, etc, can be used depending on the need.

The electric conduction washer is shown as an example. The male washer rotates inside the female washer, with a contact area; the female isolated from the outside transmits energy to the mobile part. It is worthless to show the different ways of transmitting energy in this patent. Different samples will be introduced for such purpose, as well as the transmission of energy in the rotors of the Torque Increaser. There are multiple and random ways of transmitting energy.

Due to the use range, the electronic devices correspond to independent patented inventions.

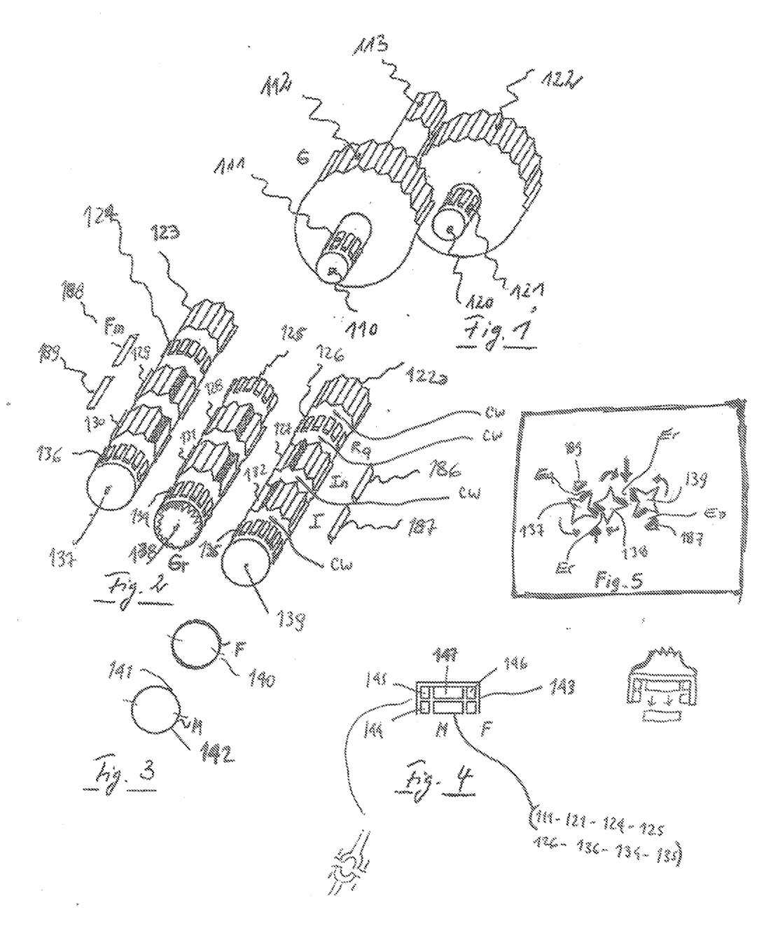

### FIG. 1 RPM MULTIPLIER

110 Second component of RPM Multiplier.

111 Magnetized Rail (component of the support)

112 Mayor radius section of the second gear of the multiplier, interlock with the torque increaser rotors

113 Minor section of the second component of the multiplier interlock with 122

122 Mayor radius section of the first component of the multiplier

120 First component of the RPM multiplier

121 Magnetized Rail (component of the support)

Magnets, electromagnets or combinations, etc. are placed in the gear teeth in order to reduce friction. As they have the same polarity they will repel each other, reducing friction through that magnetic (or electromagnetic) force (in 112,113,122)

### FIG. 2 TORQUE INCREASER

137 West component of torque increaser

138 Cut of the external section of the rotor of the generator or central component of torque increaser

139 East component of torque increaser

136-134-135-124-125-126 Magnetized rail (component of the support)

130 Torque increaser, The gear teeth are completely solid in one of their sides and hollow in the other ones. Electromagnets or magnets or combinations, etc, are placed in this hole, interlock with 131. In the interaction with 131 is the electromagnetic strength.

131 Torque increaser, The gear teeth are completely solid in one of their sides and hollow in the other ones. Electromagnets or magnets or combinations, etc, are placed in this hole , interlock with 130 and 132. In the interaction with 130 and 132 is the electromagnetic strength.

132 Torque increaser, The gear teeth are completely solid in one of their sides and hollow in the other ones. Electromagnets or magnets or combinations, etc, are placed in this hole, interlock with 130. In the interaction with 130 is the electromagnetic strength.

129 Torque increaser opposite sense, The gear teeth are completely solid in one of their sides and hollow in the other ones. Electromagnets or magnets or combinations, etc, are placed in this hole, interlock with 128. In the interaction with 128 is the electromagnetic strength.

128 Torque increaser opposite sense, The gear teeth are completely solid in one of their sides and hollow in the other ones. Electromagnets or magnets or combinations, etc, are placed in this hole, interlock with 129 and 127. In the interaction with 129 and 127 is the electromagnetic strength.

127 Torque increaser opposite sense, The gear teeth are completely solid in one of their sides and hollow in the other ones. Electromagnets or magnets or combinations, etc, are placed in this hole, interlock with 128. In the interaction with 128 is the electromagnetic strength.

122a interlock with the last component of multiplier 112 (or with an automatic gear box if necessary)

123 interlock with the last component of multiplier 112 (or with an automatic gear box if necessary)

186-187-188-189 Electromagnets fixed to the sarcophagus (electromagnetic strength in attraction) its helps to transfer the electromagnetic strength in the correct direction.

CW Places to put the conductive washer, in the necessary numbers according the electrical circuit

### FIG. 3 CONDUCTIVE WASHER

140 Female, cover the contact zone, the male part rotate inside it making contact in the central zone.

141 Contact

142 Male, Fixed to the rotor of the torque increaser, rotate inside the female part

The conductive washer (Male and Female) is consisting in to parts armed together by solder.

### FIG. 4 CUT OF THE MAGNETIC SUPPORT

Friction, to support part of the weight and act like a rail.

144-145-146 keep centered the support by means of a magnetic or electromagnetic strength, to dissipate heat in the free spaces.

147 to support part of the weight by means of a magnetic or electromagnetic strength

111-121-124-125-126-136-134-135 places to put the magnetic support, interact with 147-144-143-146-145.

### FIG. 5 FRONTAL VIEW OF THE TORQUE INCREASER COMPONENT

Shows how the rotors of torque increaser work together (Sum an electromagnetic strength)
The curved arrows shows the sense of rotation of the rotors of the torque increaser, the linear arrows shows the action of the electromagnetic strength.

137 West component of the torque increaser

138 Cut of the external section of the rotor of the generator or central component of torque increaser

139 East component of torque increaser

187-189 Electromagnets fixed to the sarcophagus (electromagnetic strength in attraction) its helps to transfer the electromagnetic strength in the correct direction.

Er Electromagnetic strength (repulsion)

Ea Electromagnetic strength (attraction)

### VINDICATION RPM MULTIPLIER WITH TORQUE INCREASER MODEL B FOR TURBINES

The RPM Multiplier with Torque Increaser model B for turbines consists of a group of different radii gears with the purpose of increasing RPM and gear type rotors to add force (either electromagnetic or magnetic or a combination of both, etc.) to the (mechanical) force of the main rotor of the turbine that activates the electric generator, producing electric energy with less mechanic energy of the main rotor of the turbine (adding either an electromagnetic or magnetic work or a combination of both, etc., being able to obtain more electric energy than the mechanic that the main rotor of the turbine transmits to the generator by means of an electromagnetic or magnetic force placed between both the rotor and the generator). The RPM Mutiplier is composed of gears with two toothed radii, one bigger than the other, being it possible to get more rigidness by means of different intermediate radii; they work as follows: the smallest toothed radius of the second gear, engages with the biggest toothed radius of the first gear, as the smallest toothed radius of the second gear. With the purpose of reducing friction, magnets (or electromagnets) are placed in the gear teeth, they have the same polarity and repel each other reducing friction by means of that magnetic (or electromagnetic) force.

The Torque Increaser model B is composed of at least a pair of gear type rotors, whether solid or not, with at least two rows of teeth each. They engage with the last gear of the Multiplier and against the rotor Generator, which presents the same amount of teeth rows in the outer part of its rotor like the multiplier gears, but oppose to them. Gear teeth incorporate electromagnets (or magnets) to one of their sides, in one direction in the first row and in the opposite direction in the second row and opposed to them those concerning the rotor generator. A row rotates to one direction and the other reversely. Electromagnets (or magnets) repel themselves, and they make electromagnetism force adds to that of the main rotor of the turbine and they work in combination against the rotor generator; in this way the rotor generator is going to be moved by the sum of the forces of the main turbine rotor (mechanic energy) and that of the electromagnetism or magnetism (electromagnetic or magnetic energy) of the Torque Increaser Model B.

There are multiple possibilities to place rotors of the Torque Increaser, depending on specific needs.

Having previously described the system it is vindicated as exclusive right and property:

RPM Multiplier with Torque Increaser model B for Turbines, described above.

As per vindication number 1

The RPM Multiplier composes of gears with two different toothed radii each. Different intermediate radii may appear in gears with the purpose of offering more resistance to work; they will be neither toothed nor will engage with other gears, they will only have structural rigidness.

It characterizes by the coupling of the biggest toothed radius of the first gear with the smallest toothed radius of the second gear, being it possible in this way the biggest toothed radius of the second gear moves in relation to the biggest toothed radius of the first gear as many times as the smallest of the second gear and successively.

As per vindications 1 to 2

It characterizes by the use of solid or hole gears with radii (to reduce weight).

As per vindications 1 to 3

It characterizes by the use of magnets or electromagnets, combinations, etc. (magnetism or electromagnetism or combinations, etc.) on the gear teeth with the purpose of reducing friction that produces during functioning (optional and random use).

As per vindications 1 to 4

It characterizes by the use of beams, support bars or rigid panels (like bedplates) to keep the system assembled.

As per vindications 1 to 5

It characterizes by the implementation of rails with permanent magnets or electromagnets, combinations, etc. in the gear joints and supports, with the purpose of reducing friction (optional and random use, any kind of assembly may be implemented).

As per vindications 1 to 6

It characterizes by the Torque Increaser model B, composed of at least two gear type rotors, with at least two rows of teeth each opposed to the rotor generator, which presents the same disposition of teeth in the opposite direction.

At least two of them (if four, six or more are used the number will be increased) will face the rotor generator gear. Gear teeth incorporate electromagnets or magnets, combinations, etc. to one of its sides on one row and to the opposite side on the other row in the outer gear of the rotor generator in the opposite direction to them.

Magnets or electromagnets, combinations, etc. will be placed optionally and at random and they will attract (or reject) diagonally gear electromagnets or magnets.

As per vindications 1 to 7

It characterizes by the use of electromagnetic or magnetic force, combinations, etc. to transfer work to the energy generator. (It is herein described model B).

As per vindications 1 to 8

It characterizes by the use of gear rotor generator in its outer part as part of the Torque increaser model B, opposed to the remaining gear rotors that compose it; electromagnets or magnets, etc. will be placed on each gear, which will work jointly with electromagnets or magnets of opposite gear type rotors.

As per vindications 1 to 9

It characterizes by the use, under the same principle and design, of pairs of double gear type rotors, that is to say, an increaser gear rotor moves another increaser gear rotor and both move the rotor generator. Consequently using double or triple, etc pairs of gears, the rotor generator will be moved by four increaser gears; in this case the intermediate gear rotor will present electromagnets or magnets on both sides.

As per vindications 1 to 10

It characterizes by the use of a group of Torque Increasers moving intermediate rotors and they move the rotor generator, for example two groups of multipliers or even more, moving only one generator, etc.

As per vindications 1 to 11

It characterizes by the possibility of multiple ways of current conduction, the only reference is the conduction washer; different options will present independently.

As per vindications 1 to 12

It characterizes by the possibility of conducting energy in a random and multiple way to the Torque Multiplier rotors.

As per vindications 1 to 13

It characterizes by the random lineal continuous succession of multiplier set components and Torque Increaser with intermediate vertical parts to place the generator on the first Increaser set, returning on it, etc. (should the set be seen laterally it will be seen as an oblong U, having the purpose of adapting to small spaces).

As per vindications 1 to 14

It characterizes by the use of the Torque Increaser between the motor and the transmission, among axes or semi axes, helices, etc. It increases torque and potence.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

1. A torque increase and/or revolution per minute (RPM) multiplier device comprising:
a main rotor;
at least one of a torque increaser gear arrangement or an RPM multiplier gear arrangement connected with the main rotor,
the torque increaser gear arrangement comprising:
a first gear comprising at least two rows of teeth, at least one tooth of a first row of teeth comprising:
a magnet on a face of the tooth, and
at least one tooth of a second row of teeth comprising:
a magnet on another face of the tooth different from the first row of teeth;
a second gear comprising at least a corresponding number of rows of teeth equal to the rows of teeth of the first gear, at least one tooth of a first corresponding row comprising a magnet on a face of the tooth in opposing arrangement with the magnet on the tooth of the first gear, at least one tooth of a second corresponding row comprising a magnet on another face of the tooth different from the magnet on the tooth of the first corresponding row; and
the RPM multiplier gear arrangement comprising:
a rail comprising one or more magnets circumferentially spaced around a periphery of the rail;
a third gear axially connected with the rail and having a first radius, at least one tooth of the third gear comprising a magnet;
a fourth gear axially connected with the rail and having a second radius, the second radius greater than the first radius;
a fifth gear having a third radius and arranged to interlock with the third gear, at least one tooth of the fifth gear comprising a magnet arranged to repel the magnet of the third gear.

2. The device as claimed in claim 1, wherein the second gear of the torque increaser is the main rotor.

3. The device as claimed in claim 1, wherein the magnet on the first corresponding row of teeth is arranged to repel the magnet on the first row of teeth.

4. The device as claimed in claim 3, wherein the magnet on the second corresponding row of teeth is arranged to repel the magnet on the second row of teeth.

5. The device as claimed in claim 1, the RPM multiplier gear arrangement further comprising another rail comprising one or more magnets circumferentially spaced around a periphery of the another rail, the fifth gear axially connected with the another rail.

6. The device as claimed in claim 1, the third gear of the RPM multiplier is the main rotor.

7. The device as claimed in claim 1, at least one torque increaser gear arrangement connected with the at least one RPM multiplier gear arrangement, the at least one RPM multiplier gear arrangement connected with the main rotor.

8. The device as claimed in claim 1, at least one RPM multiplier gear arrangement connected with the at least one torque increaser gear arrangement, the at least one torque increaser gear arrangement connected with the main rotor.
